(19) United States
(12) Patent Application Publication
(10) Pub. No.: US 2014/0131486 A1
(43) Pub. Date: May 15, 2014

(54) Electrostatic Spray Tool System

(71) Applicant: Finishing Brands Holdings Inc., Minneapolis, NM (US)

(72) Inventors: Raymond Wang, Xiangyang (CN); James Baltz, Waterville, OH (US)

(21) Appl. No.: 13/841,506

(22) Filed: Mar. 15, 2013

(30) Foreign Application Priority Data
Nov. 15, 2012 (CN) PCT/CN2012/001549

(51) Int. Cl. B05B 5/03

(52) U.S. Cl. CPC B05B 5/03
USPC 239/704

(57) ABSTRACT

A system, including an electrostatic tool, including a material passage configured to deliver a material, an air passage through the electrostatic tool, and configured to deliver compressed air for spraying the material, and a first duckbill valve within the air passage and configured to block the backflow of the material in the air passage past the duckbill.

### CROSS REFERENCE TO RELATED APPLICATION

This application claims priority to and benefit of PCT Patent Application No. PCT/CN2012/001549 entitled “ELECTROSTATIC SPRAY TOOL SYSTEM”, filed Nov. 15, 2012, which is herein incorporated by reference in its entirety.

### BACKGROUND

The invention relates generally to an electrostatic spray tool.

Electrostatic spray tools output sprays of electrically charged materials to more efficiently coat objects. For example, electrostatic tools may be used to paint objects. In operation, a grounded target attracts electrically charged materials sprayed with compressed air from an electrostatic tool. As the electrically charged material contacts the grounded target, the material loses the electrical charge. Unfortunately after spraying, some of the unsprayed excess material may flow into the air passageways causing maintenance issues.

### BRIEF DESCRIPTION

In a first embodiment a system, including an electrostatic tool including a material passage configured to deliver a material, an air passage through the electrostatic tool, and configured to deliver compressed air for spraying the material, and a first duckbill valve within the air passage and configured to block the backflow of the material in the air passage past the duckbill.

In another embodiment a system, including an electrostatic tool, including a handle portion including an electrical generator, a barrel portion coupled to the handle portion, a first duckbill valve configured block a fluid from back flowing through electrostatic tool and into contact with the electrical generator.

In another embodiment a system, including an electrostatic tool including a handle portion including an electrical generator and an electric generator air passage, a barrel portion coupled to the handle portion, a first duckbill valve configured to block a fluid from back flowing through a shaping air passage, and a second duckbill valve configured to block fluid from back flowing through an atomization air passage.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional side view of an embodiment of an electrostatic tool system capable of blocking fluid backflow;

FIG. 2 is a cross-sectional top view of an embodiment of an electrostatic tool capable of blocking fluid backflow;

FIG. 3 is a perspective view of an embodiment of a duckbill valve; and

FIG. 4 is a cross-sectional side view of an embodiment of a duckbill valve in open and closed positions.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to an electrostatic tool system capable of electrically charging a material sprayed with compressed air. More specifically, the disclosure is directed towards a system for blocking the backflow of unsprayed excess material in the electrostatic tool. For example, the electrostatic tool system may include one-way valves or check valves (e.g., duckbill valves) to block the backflow of unsprayed excess material. The one-way valves enable compressed airflow through the electrostatic tool in one direction, but block excess unsprayed material from back flowing into the electrostatic tool in the opposite direction. The inability of the excess material to backflow through the electrostatic tool protects components from unnecessary maintenance (i.e., helps reduce plugging, less waste of material, and less excess material to clean out).

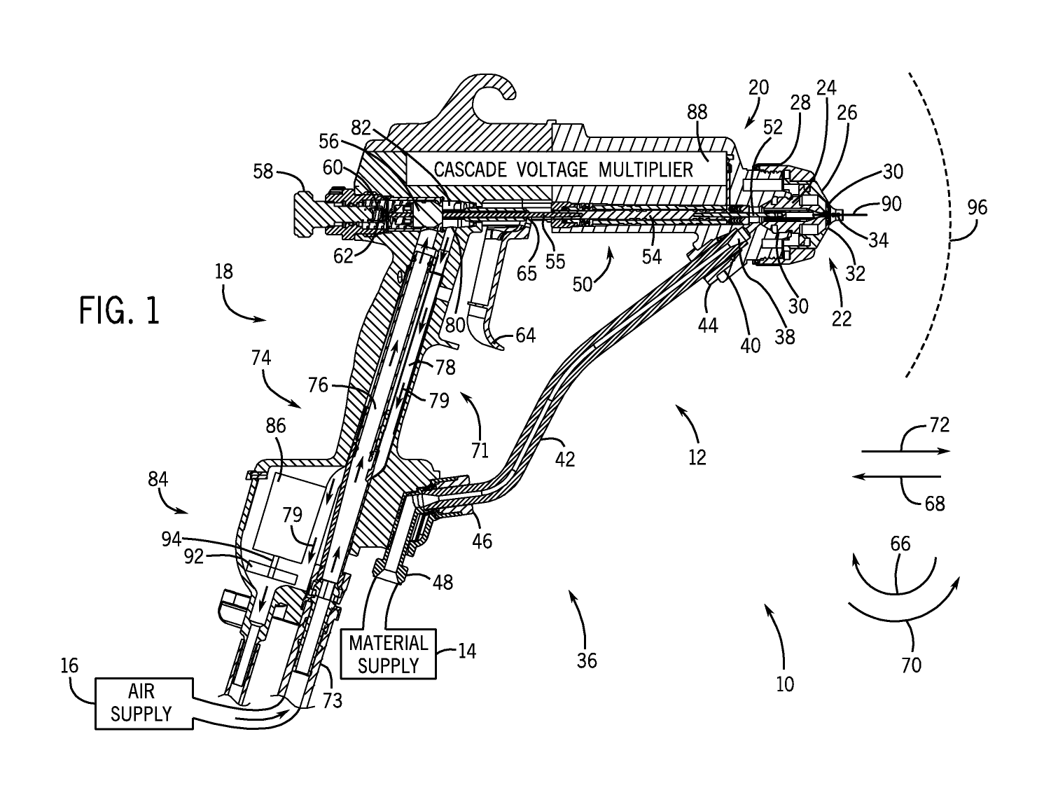

FIG. 1 is a cross-sectional side view of an embodiment of an electrostatic tool system 10 capable of blocking fluid backflow. As illustrated, the electrostatic tool system 10 includes an electrostatic tool 12 configured to electrically charge and spray a material (e.g., paint, solvent, etc.) towards an electrically attractive target. The electrostatic tool 12 receives sprayable material from a material supply 14, which the electrostatic tool 12 sprays with compressed air from an air supply 16. After spraying, some excess unsprayed material may remain in the electrostatic tool 12. The electrostatic tool 12 includes one or more one-way valves (e.g., duckbill valves), which block the backflow of excess material through the electrostatic tool 12.

As illustrated, the electrostatic tool 12 includes a handle 18, a barrel 20, and a spray tip assembly 22. The spray tip assembly 22 includes a fluid nozzle 24, an air atomization cap 26, and retaining ring 28. The fluid nozzle 24 may be removably inserted into a receptacle 30 of the barrel 20. As illustrated, the air atomization cap 26 covers the fluid nozzle 24, and is removably secured to the barrel 20 with the retaining ring 28. The air atomization cap 26 includes a variety of air atomization orifices, such as a central atomization orifice 30 disposed about a liquid tip exit 32 from the fluid nozzle 24. The air atomization cap 26 may also have one or more spray shaping air orifices, such as spray shaping orifices 34 that use air jets to force the spray to form a desired spray pattern (e.g., a flat spray). The spray tip assembly 22 may also include a variety of other atomization mechanisms to provide a desired spray pattern and droplet distribution.

The electrostatic tool 12 includes a variety of controls and supply mechanisms for the spray tip assembly 22. As illustrated, the electrostatic tool 12 includes a liquid delivery assembly 36 having a liquid passage 38 extending from a liquid inlet coupling 40 to the fluid nozzle 24. Included in the liquid delivery assembly 36 is a liquid tube 42. The liquid tube 42 includes a first tube connector 44 and a second tube connector 46. The first tube connector 44 couples the liquid tube 42 to the liquid inlet coupling 40. The second tube connector 46 couples the liquid tube to the handle 18. The handle 18 includes a material supply coupling 48, enabling the electrostatic tool 12 to receive material from the material supply 14. Accordingly, during operation, the material flows from the material supply 14 through the handle 18 and into the liquid tube 42 where the material is transported to the fluid nozzle 24 for spraying.

In order to control liquid and air flow, the electrostatic tool 12 includes a valve assembly 50. As will be explained in more detail below, the valve assembly 50 simultaneously controls liquid and air flow as the valve assembly 50 opens and closes. The valve assembly 50 extends from the handle 18 to the barrel 20. The illustrated valve assembly 50 includes a fluid nozzle needle 52, a shaft 54, and an air valve needle 55 which couples to an air valve 56. The valve assembly 50 movably extends between the liquid nozzle 24 and a liquid adjuster 58. The liquid adjuster 58 is rotatably adjustable against a spring 60 disposed between the air valve 56 and an internal portion 62 of the liquid adjuster 58. The valve assembly 50 is also coupled to a trigger 64 at point 65, such that the fluid nozzle needle 52 of the valve assembly 50 may be moved inwardly away from the fluid nozzle 24 as the trigger 64 is rotated in a clockwise direction 66. More specifically, rotation of the trigger 64 in a clockwise direction 66 moves the valve assembly 50 in direction 68 retracting the fluid nozzle needle 52, enabling fluid to flow into the fluid nozzle 24. Similarly, when the trigger 64 rotates in a counter-clockwise direction 70, the fluid nozzle needle 52 moves in direction 72 sealing the fluid nozzle 24 and blocking further fluid flow.

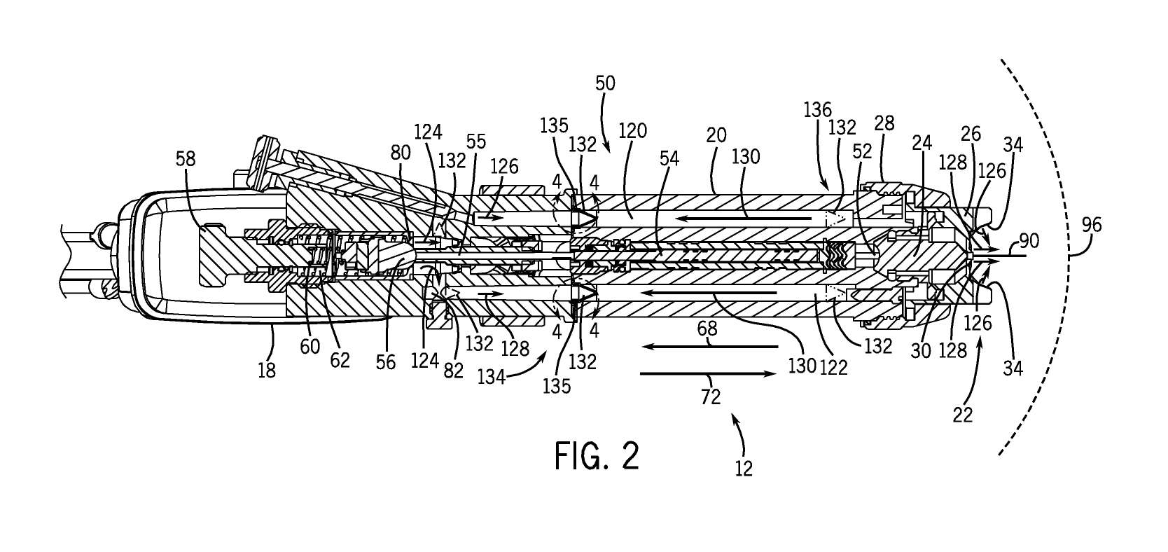

An air supply assembly 71 is also disposed in an electrostatic tool 12 enabling atomization at the spray tip assembly 22, with compressed air from the air supply 16. The illustrated air supply assembly 71 extends from an air inlet 73 to the spray tip assembly 22 through an air passage 74 to the air atomization cap 26. The air passage 74 includes multiple air passages including a main air passage 76, an electric generator air passage 78, an atomization air passage 122 (seen in FIG. 2), and a shaping air passage 120 (seen in FIG. 2). As mentioned above, the valve assembly 50 controls fluid and air flow through the electrostatic tool 12 through movement of the trigger 64. As the trigger 64 rotates in a clockwise direction 66, the trigger 64 opens the air valve 56. More specifically, rotation of the trigger 64 in a clockwise direction 66 induces movement of the air valve 56 in direction 68 through movement of the air valve needle 55. As the air valve 56 moves in direction 68, the air valve 56 unseats from the sealing seat 80, enabling air to flow from the main air passage 76 into an air plenum 82. The air plenum 82 communicates with and facilitates airflow from the main air passage 76 into the electric generator air passage 78, the atomization air passage 122 (seen in FIG. 2), and the shaping air passage 120 (seen in FIG. 2). In contrast, when the trigger 64 rotates in a counter-clockwise direction 70, the air valve 56 moves in direction 68 resealing with the sealing seat 80. Once the air valve 56 reseals with the sealing seat 80, air is unable to travel from the air supply 16 through the main air passage 76 and into the air plenum 82, for distribution into electric generator air passage 78, the atomization air passage 122 (seen in FIG. 2), and the shaping air passage 120 (seen in FIG. 2). Accordingly, activation of the trigger 64 enables simultaneous liquid and airflow to the spray tip assembly 22. Indeed, once an operator pulls the trigger 64, the valve assembly 50 moves in direction 68. The movement of the valve assembly 50 in direction 68 induces the fluid nozzle needle 52 to retract from the fluid nozzle 24, enabling fluid to enter the fluid nozzle 24. Simultaneously, movement of the valve assembly 50 induces the air valve 56 to unseat from the sealing seat 80, enabling air flow through the main air passage 76 and into the air plenum 82. The air plenum 82 then distributes the air for use by the spray tip assembly 22 (i.e., to shape and atomize), and by the power assembly 84.

The power assembly 84 includes an electric generator 86, a cascade voltage multiplier 88, and an ionization needle 90. As explained above, the air plenum 82 enables air flow to distribute into an electric generator air passage 78. The electrical generator air passage 78 directs airflow 79 from the air plenum 82 back through the handle 18 and into contact with a turbine (e.g., a plurality of blades) or fan 92. The airflow induces the turbine 92 to rotate a shaft 94. The electrical generator 86 converts the mechanical energy from the rotating shaft 94 into electrical power for use by the cascade voltage multiplier 88. The cascade voltage multiplier 88 is an electrical circuit, which converts low voltage alternating current (AC) from the electrical generator 86 into high voltage direct current (DC). The cascade voltage multiplier 88 outputs the high voltage direct current to the ionization needle 90, which then creates an ionization field 96 for electrically charging atomized liquid sprayed by the electrostatic tool 12.

FIG. 2 is a cross-sectional top view of an embodiment of the electrostatic tool 12 capable of blocking fluid backflow. As illustrated, the air plenum 82 is in fluid communication with the shaping air passage 120 and the atomization air passage 122. As explained above, when the trigger 64 (seen in FIG. 1) rotates in a clockwise direction 66, the valve assembly 50 moves in direction 68. As the valve assembly 50 moves in direction 68, the air valve 56 disengages from the valve seat 80, enabling air 124 to flow in direction 72 and into the air plenum 82. In the air plenum 82, the air 124 splits into the shaping air passage 120, the atomization air passage 122, and the electrical generator air passage 78 (seen in FIG. 1). The shaping air passage 120 and atomization air passage 122 then guide the air to the spray tip assembly 22. More specifically, the shaping air passage 120 guides air 126 to the spray shaping orifices 34 in the atomization cap 26, where the air 126 shapes the spraying pattern of the electrostatic tool 12. The air 128 travels parallel to the air 126 and into the air atomization cap 26, where the air 126 atomizes the fluid and exits through the central atomization orifice 30. Upon exiting the central orifice 30, the atomized fluid is electrically charged in the ionization field 96 produced by the ionization needle 90. As explained above, once the operator releases the trigger 64 (seen in FIG. 1), airflow through the plenum 82 and fluid flow through the fluid nozzle 24 stops. More specifically, as the valve assembly 50 moves in direction 72, the air valve 56 reseats in the seat 80, blocking air flow into the plenum 82. However, excess unsprayed material may still remain within the spray tip assembly 22. The excess material 130 may then backflow through the shaping air passage 120 and the atomization air passage 122 in direction 68. As explained above, if excess material 130 enters the air plenum 82, the excess material 130 may then travel through the electrical generator air passage 78 and into contact with the electrical generator assembly 84. Accordingly, the disclosed embodiment includes one-way valves 132 (e.g., duckbill valves), which prohibit excess unsprayed material from back flowing into the air plenum 82.

As illustrated, the electrostatic tool 12 includes two valves 132. One valve 132 is placed in the shaping air passage 120, and a second valve 132 is placed in the atomization air passage 122. The valves 132 enable air flow through the shaping air passage 120 and the atomization air passage 122 in the direction 72, but block fluid flow in direction 68. In this manner, the valves 132 enable airflow for spraying, while simultaneously protecting components in the electrostatic tool 12 (e.g., the electrical generator assembly 84) from excess unsprayed material 130. In the present embodiment, the valves 132 are placed in the atomization air passage 122 and the shaping air passage 120 at region 134, or more specifically at the location where the barrel 20 joins the handle 18. Since region 134 is an assembly region for the electrostatic tool 12, region 134 enables easy access to the valves 132 for replacement, inspection, and retrofitting previous manufactured electrostatic tools 12. Indeed, region 134 may include counterbores 135, which receive a corresponding flange of the valves 132. However, in other embodiments, the valves 132 may be placed at several locations, including in the plenum 82 or further downstream (i.e., in direction 72) in the atomization air passage 122 or the shaping air passage 120 (e.g., at region 136). For example, the air plenum 82 may include two valves 132 one for each of the respective passages 120 and 122. In another embodiment, the air plenum 82 may include a single valve 132 capable of blocking backflow through the both of the passages 120 and 122. In still other embodiments, the electrostatic tool 12 may include valves 132 at multiple locations (e.g., in the air plenum 82, at region 134, or at region 136). The use of multiple valves 132 may therefore provide redundant blocking of excess unsprayed material.

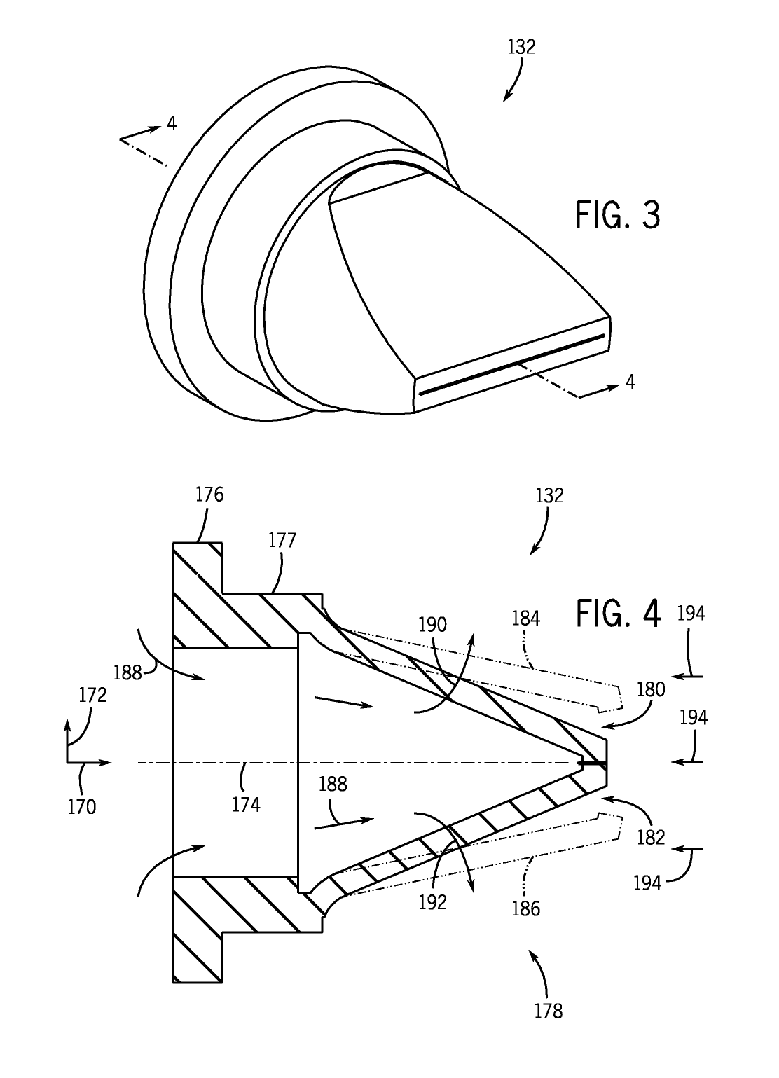

FIG. 3 is a perspective view of an embodiment of a duckbill valve 132. As explained above, the duckbill valve 132 functions as a one-way valve blocking unsprayed excess material (e.g., liquid) from contacting components within the electrostatic tool 12 (seen in FIG. 1). The duckbill valve 132 may be made from different materials depending on the application and the sprayed material. For example the valve 132 maybe made from a solvent resistant fluoroelastomer, a solvent proof perfluoroelastomer, or a nitrile rubber with no solvent resistance. Indeed, the electrostatic tool 12 may change the type of duckbill valve 132 depending on the type of sprayed material, in order to maximize duckbill 132 resistance to unsprayed excess material backflow.

FIG. 4 is a cross-sectional side view of an embodiment of the duckbill valve 132 in open and closed positions. For purposes of discussion, reference may be made to an axial direction 170 and radial direction 172 relative to a longitudinal axis 174 of the valve 132. Further, one-way valve 132 has a mounting flange 176 and a valve section 178. As discussed above, the valve 132 is configured to be mounted within the air passages of the electrostatic tool 12. For example, when mounting valve 132 within the air passages of the electrostatic tool 12, mounting flange 176 may be configured mount in the counterbore 135 (seen in FIG. 2). In other embodiments, the valve 132 may not include a mounting flange 176, but may instead be friction fit into an air passage with an exterior mounting surface 177. As illustrated in FIG. 4, valve section 178 includes an upper resilient flap 180 and a lower resilient flap 182, which are shown in a closed position as indicated by solid lines. An open position of valve section 178 is shown in dashed lines, as indicated by dashed flaps 184 and 186. In operation, the valve 132 functions as a one-way valve. More specifically, when compressed air 188 flows through the valve 132, the air contacts the upper flap 180 and the lower flap 182. Once the force of the airflow 188 exceeds the resistance of the flaps 180 and 182, the upper and lower resilient flaps 180 and 182 open in opposite radial directions 172 away from one another (e.g., to the open position indicated by dashed flaps 184 and 186). More specifically, the flaps 180 and 182 rotate in directions 190 and 192 under the force of the airflow 188 flowing in axial direction 170. When the air 188 stops flowing through the valve 132 the flaps return to a closed position, which blocks fluid flow 194 flowing in the opposite axial direction of 170 (e.g., excess unsprayed material). Accordingly, the valve 132 is configured in such a manner as to block flow when at rest. Therefore, because valve section 178 only allows flow in axial direction 170 when airflow 188 exceeds the resistance of the flaps 180 and 182, flow through valve section 178 only occurs unidirectionally along axial direction 170. The unidirectional flow configuration of the valve 132 blocks reverse flow through valve section 178, enabling airflow for shaping and atomizing, but blocks unsprayed excess material (e.g., liquid) backflow 194 from contacting components of the electrostatic tool 12.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an electrostatic tool comprising:
a material passage configured to deliver a material;
an air passage through the electrostatic tool and configured to deliver compressed air for spraying the material; and
a first duckbill valve within the air passage and configured to block the backflow of the material in the air passage past the duckbill.

2. The system of claim 1, wherein the air passage comprises a main air passage.

3. The system of claim 2, wherein the air passages includes an air plenum in fluid communication with the main air passage.

4. The system of claim 3, wherein the air passage includes a shaping air passage, an atomization air passage, and an electric generator air passage, wherein the air plenum is in fluid communication with and configured to distribute airflow from the main air passage into the shaping air passage, the atomization air passage, and the electric generator air passage.

5. The system of claim 4, wherein the atomization air passage includes the first duckbill valve configured to block the backflow of the material through the atomization air passage.

6. The system of claim 4, comprising a second duckbill valve, wherein the second duckbill valve rests in the shaping air passage and is configured to block the backflow of the material through the shaping air passage.

7. The system of claim 4, wherein the first duckbill valve rests in the air plenum and is configured to block the backflow of material through the shaping air passage and the atomization air passage.

8. The system of claim 1, wherein the first duckbill valve is made from a fluoroelaastomer, a perfluoroelastomer, or nitrile.

9. The system of claim 6, wherein the second duckbill valve is made from a fluoroelaastomer, a perfluoroelastomer, or nitrile.

10. A system, comprising:
an electrostatic tool, comprising:
a handle portion including an electrical generator;
a barrel portion coupled to the handle portion;
a first duckbill valve configured block a fluid from back flowing through electrostatic tool and into contact with the electrical generator.

11. The system of claim 10, wherein the handle includes a main air passage, an air plenum, a shaping air passage, an atomization air passage, and an electric generator air passage.

12. The system of claim 11, wherein the air plenum is in fluid communication with the main air passage, the shaping air passage, the atomization air passage, and the electric generator air passage, and wherein the air plenum enables airflow to travel from the main air passage into the shaping air passage, the atomization air passage, and the electric generator air passage.

13. The system of claim 12, wherein the barrel includes a shaping air passage and an atomization air passage in fluid communication with the shaping air passage and the atomization air passage of the handle.

14. The system of claim 13, wherein the barrel includes the first duckbill valve in the atomization air passage, and the first duckbill valve is configured to block fluid from black flowing through the atomization air passage from the barrel into the handle.

15. The system of claim 13, wherein the barrel includes a second duckbill valve in the shaping air passage, and the second duckbill valve is configured to block fluid from back flowing through the shaping air passage from the barrel into the handle.

16. The system of claim 13, wherein the handle includes the first duckbill valve within the air plenum, and the first duckbill valve is configured to block fluid from back flowing into the electric generator passage.

17. The system of claim 10, wherein the first duckbill valve is made from a fluoroelastomer, a perfluoroelastomer, or nitrile.

18. The system of claim 13, wherein the second duckbill valve is made from a fluoroelastomer, a perfluoroelastomer, or nitrile.

19. A system, comprising:
an electrostatic tool comprising:
a handle portion including an electrical generator and an electric generator air passage;
a barrel portion coupled to the handle portion;
a first duckbill valve configured to block a fluid from back flowing through a shaping air passage; and
a second duckbill valve configured to block fluid from back flowing through an atomization air passage.

20. The system of claim 19, wherein the handle portion includes an air plenum in communication with the electric generator air passage, the shaping air passage, and the atomization air passage, wherein the air plenum includes a third duckbill valve configured to block fluid from back flowing into the electric generator air passage.
